(19) United States
(12) Patent Application Publication
(10) Pub. No.: US 2007/0035512 A1
(43) Pub. Date: Feb. 15, 2007

(54) 3D image display device using integral imaging technology

(75) Inventors: Dae-sik Kim, Suwon-si (KR); Sung-yong Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/492,121

(22) Filed: Jul. 25, 2006

(30) Foreign Application Priority Data
Jul. 26, 2005 (KR) 10-2005-0067843

(51) Int. Cl. G09G 5/00

(52) U.S. Cl. 345/156

(57) ABSTRACT

A three dimensional (3D) image display using integral imaging technology is provided. The 3D image display A three dimensional (3D) image display comprises: a point light source array; a display element modulating incident light from the point light source array pixel by pixel by electric control to form an image; and a mode converter placed between the point light source array and the display element and capable of being converted into a transparent medium and a scattering medium by electric switching, wherein the 3D image display device is in a 3D mode when the mode converter is a transparent medium and in a 2D mode when the mode converter is a scattering medium. Thus, the viewing angle can be extended and 2D images and 3D images can be selectively switched.

### CROSS-REFERENCE TO RELATED PATENT APPLICATION

This application claims priority from Korean Patent Application No. 10-2005-0067843, filed on Jul. 26, 2005, in the Korean Intellectual Property Office, the disclosure of which is incorporated herein in its entirety by reference.

### BACKGROUND OF THE INVENTION

1. Field of the Invention

The present invention relates to a three dimensional (3D) image display device using integral imaging technology, and more particularly, to a 3D image display device using integral imaging technology in which two dimensional (2D) and 3D images can be converted and the viewing angle is extended.

2. Description of the Related Art

In general, a three dimensional (3D) image is displayed by holography methods or by stereography methods. Holography methods may be ideal but require coherent light, and have difficulty in recording and reproducing a large object placed at a distance. Stereoscopy methods separately show two dimensional (2D) images to each eye, the images being binocular and parallel, to create the illusion of depth in an image. Since stereography methods use two planar images, realization is easy and 3D images having high resolution and great visual depth can be displayed. However, stereoscopy methods use only a difference in horizontal perspective, so that 3D images having horizontal and vertical perspective differences cannot be realized. In addition, the convergence angle of the eyes viewing the image and the focus of the image may be different, thus tiring the eyes. Also, there is only one fixed perspective or several separated perspectives, so that the image is inconsecutive. To solve such problems, an image display method using integral imaging has been suggested.

In integral imaging technology, a 3D object is stored into a 2D image array using a lens array including a plurality of basic lenses, and then the 2D image is reproduced into a 3D image of the object. FIG. 1 is a schematic view of a conventional 3D image display device using integral imaging. The 3D image display device includes an image obtaining unit 10 and an image display unit 20. The image obtaining unit 10 includes a photographing unit 11 which has a first lens array 13 for photographing an object O and a recording unit 15 recording the photographed image as a 2D image. The image display unit 20 includes a display device 21 receiving the 2D image from the recording unit 15 and reconstructing the received image to a 3D image and a second lens array 25 imaging the 3D image using integral imaging technology.

However, the conventional 3D image display device using integral imaging technology has low resolution and image depth, and a small viewing angle. In particular, since the size of the basic lenses which constitute the first and second lens arrays 13 and 25 is limited with respect to the viewing angle, the size of the region in which basic images corresponding to each basic lens will be displayed is limited. Accordingly, the smaller the F number value of the basic lenses, the greater the viewing angle but the larger the aberration, resulting in distortion of the reproduced images. Thus there is a limit to how much the viewing angle should be increased.

### SUMMARY OF THE INVENTION

An aspect of the present invention provides a 3D image display device using integral imaging technology in which the viewing angle is extended.

An aspect of the present invention also provides a 3D image display device using integral imaging technology in which 2D images and 3D images can be converted.

According to an aspect of the present invention, a three dimensional (3D) image display comprises: a point light source array; a display element modulating incident light from the point light source array pixel by pixel by electric control to form an image; and a mode converter placed between the point light source array and the display element and capable of being converted into a transparent medium and a scattering medium by electric switching, wherein the 3D image display device is in a 3D mode when the mode converter is a transparent medium and in a 2D mode when the mode converter is a scattering medium.

The point light source array may be installed inside the mode converter.

The refractive index of the mode converter may be greater than 1.

The mode converter may be formed of high polymer distributed liquid crystals.

Optical fibers or a pin hole array may be bonded between the point light source array and the mode converter.

According to an aspect of the present invention, there is provided a three dimensional (3D) image display device comprising: a point light source array unit forming a point light source array; a correcting element correcting a divergence angle of light emitted from the point light source array unit; a mode converter bonded with the correcting element and capable of being converted into a transparent medium and a scattering medium by electric control; and a display element modulating incident light passing through the mode converter pixel by pixel by electric control to form an image.

The point light source array unit may comprise: a light source; a condensing lens focusing light emitted from the light source; a collimating lens collimating the light that passed through the condensing lens; and a micro lens array having a plurality of unit micro lenses and focusing parallel light using the unit micro lenses to form a point light source array.

The correcting element may include a lens array having a negative power.

According to an aspect of the present invention, there is provided a 3D image display device comprising: a point light source array unit forming a light source array; a correcting element correcting a divergence angle of light emitted from the point light source array unit; a transparent medium element bonded with the correcting element and having a refractive index greater than 1; and a display element modulating incident light passing through the transparent medium element pixel by pixel by electric control.

### BRIEF DESCRIPTION OF THE DRAWINGS

The above and other aspects of the present invention will become more apparent by describing in detail exemplary embodiments thereof with reference to the attached drawings in which:

FIG. 1 shows a conventional 3D image display device using integral imaging technology;

FIG. 2 is a schematic view of a 3D image display device using integral imaging according to an exemplary embodiment of the present invention;

FIG. 3A illustrates a modified example of a point light source array of the 3D image display using integral imaging illustrated in FIG. 2;

FIG. 3B illustrates another modified example of a point light source array of the 3D image display device using integral imaging illustrated in FIG. 2;

FIG. 4 illustrates a modified example of a 3D image display device illustrated in FIG. 2;

FIG. 5A illustrates the diffusion angle of the viewing angle in the 3D image display device illustrated in FIG. 2;

FIG. 5B illustrates the diffusion angle of the viewing angle in the 3D image display device illustrated in FIG. 4;

FIG. 6 illustrates a 3D image display device using integral imaging according to another exemplary embodiment of the present invention; and

FIG. 7 illustrates the extension of the viewing angle using a correcting element included in the 3D image display device illustrated in FIG. 6.

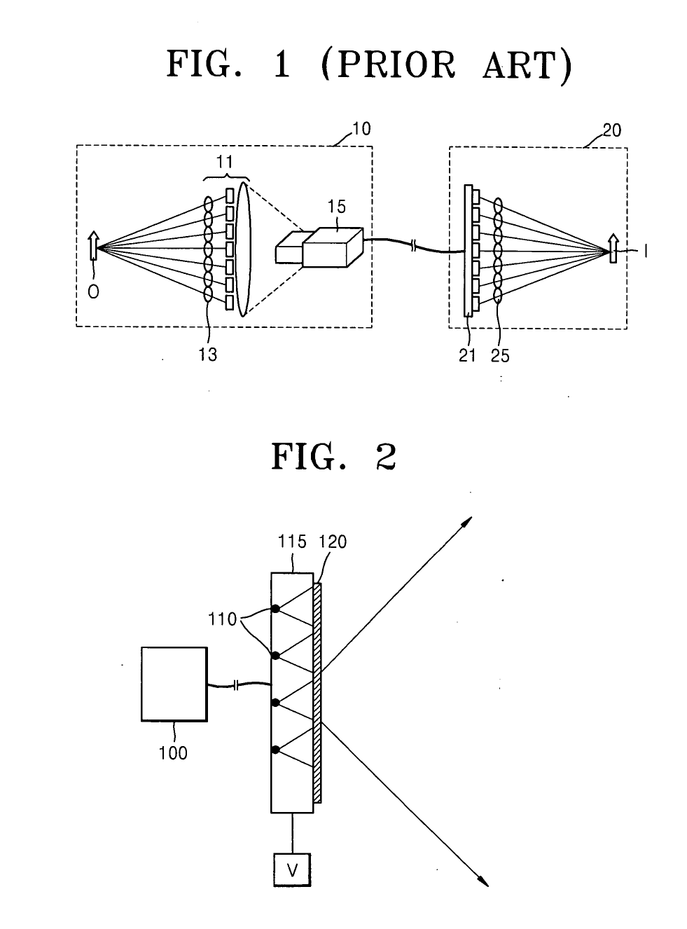

### DETAILED DESCRIPTION OF THE INVENTION

Referring to FIG. 2, a 3D image display using integral imaging technology according to an exemplary embodiment of the present invention includes an image obtaining unit 100 photographing an object as a 3D image and converting the 3D image to a 2D image, and a point light source array 110 and a display element 120 so as to display the received image from the image obtaining unit 100 in multiple perspectives.

The image obtaining unit 100 can be configured in various ways and is easily manufactured by those skilled in the art, so its description will be omitted.

A mode converter 115 for converting a 2D mode displayed in a 2D image and a 3D mode displayed in a 3D image is placed between the point light source array 110 and the display panel 120. The mode converter 115 can be converted into a transparent medium and a scattering medium by electric switching of a driving unit V. When the mode converter 115 is a transparent medium, it is a 3D mode, and when the mode converter 115 is a scattering medium, it is a 2D mode. For example, the mode converter 115 may be formed of high polymer distributed liquid crystals. The mode converter 115 serves as a transparent medium when a voltage is not applied, transmitting and refracting an incident light. When a voltage is applied by the driving unit V, the mode converter 115 which is then a scattering medium, scatters the incident light so as to serve as a diffuse substrate and realize a 2D image. That is, when the mode converter 115 serves as a scattering medium, light emitted from the point light source array 110 is mixed and an image having multiple viewing points is displayed as a 2D image.

The mode converter 115 may have a refractive index greater than 1. When the refractive index is greater than 1, the viewing angle can be extended.

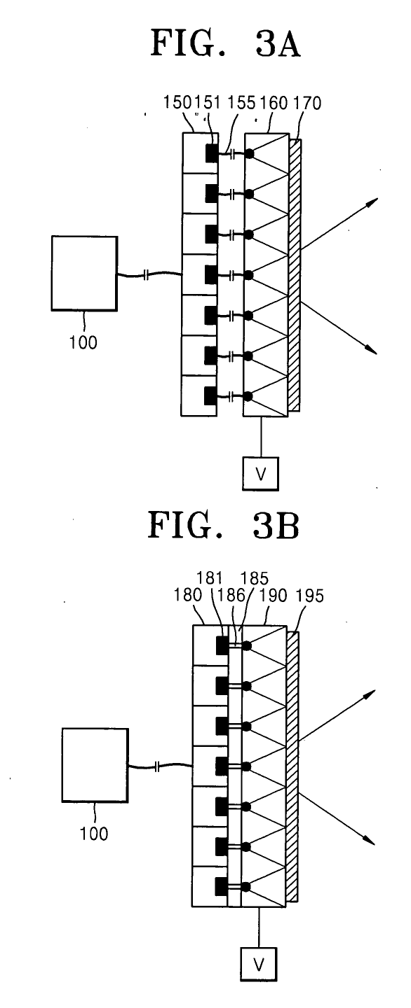

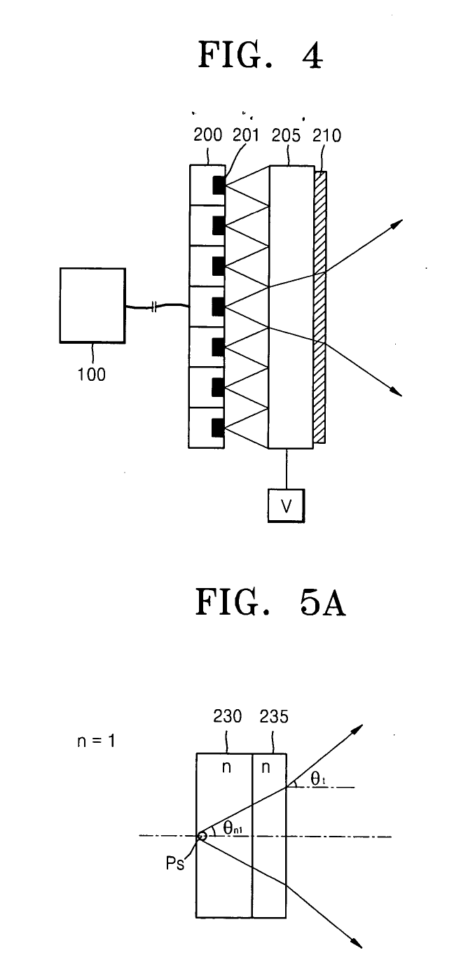

The point light source array 110 may be buried inside the mode converter 115 or placed outside the mode converter 115. FIGS. 2, 3A, and 3B illustrate examples of a point light source array buried inside the mode converter 115, and FIG. 4 illustrates a point light source array placed outside the mode converter 115.

The point light source array 110 includes a plurality of point light sources such as arc lamps, laser diodes, and light emitting diodes arranged in an array. FIG. 2 illustrates a point light source array 110 included inside the mode converter 115. The viewing angle is extended when light emitted from each point light source travels to the outside by the mode converter 115 compared to when a point light source array is placed outside the mode converter 115, which will be described later.

The display device 120 may be a liquid crystal display (LCD) or a ferro liquid crystal display (FLCD) modulating light electrically to form an image.

FIG. 3A illustrates an example in which optical fibers 155 are disposed between a point light source array 150 and a mode converter 160. Each end of the optical fibers 155 is bonded with a respective point light source 151 of the point light source array 150, and the other end of the light fibers 155 is bonded inside the mode converter 160. In a 3D mode, a light emitted from the light source 151 is emitted from the other end of the optical fibers 155 and the viewing angle is extended through the mode converter 160. Reference numeral 170 denotes a display device.

FIG. 3B illustrates a pin hole array 185 placed between a point light source array 180 and a mode converter 195. The pin hole array 185 includes a pin hole 186 corresponding to each of the point light sources 181. Light emitted from each of the point light sources 181 is diffused through a pin hole 186 and passes through the mode converter 195. The pin hole array 185 and the mode converter 195 are closely adhered. Reference numeral 190 denotes a display element.

Described above are a point light source array or optical fibers bonded with the point light source array or a pin hole array bonded inside the mode converter. As illustrated in FIG. 4, a point light source array 200 can be placed outside a mode converter 205 as well. Light emitted from each of the point light sources 201 is incident on a display device 210 through the mode converter 205. The mode converter 205, as described above, can convert a 3D mode and a 2D mode by being converted into a transparent medium or a scattering medium by electric on/off control.

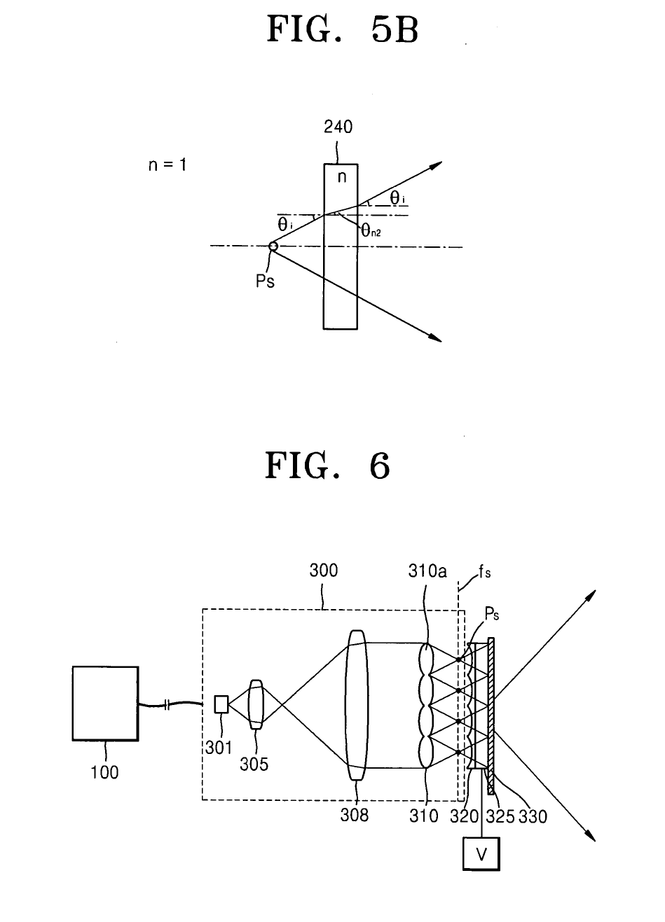

When a point light source array is placed outside or inside a mode converter, the degree of diffusion of the viewing angle varies. FIG. 5A illustrates an example in which a point light source Ps is placed inside a medium 230 having the same refractive index as a mode converter 235. FIG. 5B illustrates an example in which a point light source is placed outside the mode converter. Here, only one point light source Ps is illustrated for convenience of explanation.

When a point light source array is installed inside a mode converter, as illustrated in FIG. 2, the point light source array may be right inside the point light source, or, as illustrated in FIG. 5A, an additional medium 230 made of a material having the same refractive index as the mode converter 235 may be provided and a point light source Ps may be placed inside the medium 230.

When the refractive indexes of the medium 230 and the mode converter 235 are greater than 1, the emission angle of light from the point light source Ps is θₙ₁, and the refractive angle from the mode converter 235 to an external medium having the refractive index of 1 is θᵣ, n sin θₙ₁=sin θᵣ, according to Snell's Law. Since the refractive index n is greater than 1, θᵣ>θₙ₁.

Referring to FIG. 5B, when the incident angle from the point light source Ps to a mode converting medium 240 is θᵢ, and the refractive index of the mode converting medium 240 is θₙ₂, sin θᵢ=n sin θₙ₂ according to Snell's Law. Since the refractive index n is greater than 1, θᵢ>θₙ₂. Light is emitted at the angle θᵢ when the light passes through the mode converting medium 240.

Comparing FIGS. 5A and 5B, when the emission angles θₙ₁ and θᵢ of the light emitted from the point light source Ps and θᵢ are the same, the following equation can be obtained.
θₙ₂<θᵢ=θₙ₁<θ (1)

According to Equation 1, when a point light source is installed inside the mode converter, the viewing angle is greater than in a point light source installed outside the mode converter.

According to another embodiment of the present invention, referring to FIG. 6, a 3D image display device includes a point light source array unit 300, a correcting element 320 for adjusting the divergence angle of the light emitted from the point light source array unit 300, and a mode converter 325 that can be converted into a transparent medium and a scattering medium by electric switching. A display element 330 displays a 2D image or a 3D image using light that passed through the mode converter 325.

The point light source array unit 300 includes a light source 301, a condensing lens 305 focusing the light emitted from the light source 301, a collimating lens 308 collimating the light that passed through the condensing lens 305, and a micro lens array 310. The light source 301 may be an arc lamp, a laser diode, a light emitting diode, or other light source suitable for the application.

The micro lens array 310 includes unit micro lenses 310a, and parallel light is focused by the unit micro lenses 310a to form a point light source array on a focus surface fs.

In addition, the point light source array unit 300, as illustrated in FIG. 3A, can include a point light source array 150 and optical fibers 155, and the ends of the optical fibers 155 can face the correcting device 320. Also, as illustrated in FIG. 3B, the point light source array unit 300 can include a point light source array 180 and a pin hole array 185, and the pin hole array 185 can face the correcting element 320.

The correcting element 320 adjusts the emission angle of light emitted from the light source array unit 300 to enter the mode converter 325 without refraction. The correcting element 320 can include a lens array having a negative power. The lens array of the correcting element 320 corresponds to the unit micro lens.

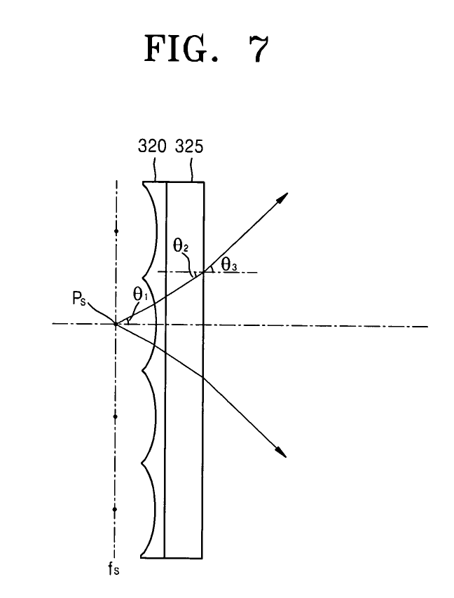

The divergence angle of the light emitted from the light source array unit 300 is increased by the correcting element 320, and the light is incident on the mode converter 325. Referring to FIG. 7, when the emission angle of the light from the point light source Ps is θ₁, and the divergence angle of the light diverged by the correcting element 320 is θ₂, and the refractive angle of the light emitted from the mode converter 325 is θ₃, then θ₁<θ₂<θ₃. When the refractive indexes of the correcting element 320 and the mode converter 325 are the same, the divergence angle θ₂ of the correcting element 320 and the incident angle of the mode converter 325 is the same. When the incident angle θ₂ of the light emitted from the mode converter 325 increases, the refractive angle θ₃ increases in proportion to the incident angle. Thus the viewing angle is extended. When the refractive angle θ₃ is the same as the emission angle θ₁ of the light emitted from the point light source array unit 300, the correcting device 320 and the mode converter 325 serves as a transparent medium, so that the same effect is obtained as when light is emitted from a point light source array and transmitted without refraction.

For example, the mode converter 325 can be made of high polymer distributed liquid crystals, and be converted into a transparent medium or a scattering medium by electric switching.

The mode converter 325 can be replaced with an element which is a transparent medium having a refractive index greater than 1. When the mode converter 325 is replaced with a transparent medium, only 3D images can be displayed.

In the above embodiment, the viewing angle is extended when the point light source array unit 300 is installed outside the mode converter 325. When necessary, the 3D image display device can be more easily manufactured when the point light source array unit 300 is installed outside the mode converter 325.

As described above, the 3D image display device according to the present invention realizes a 3D image using integral imaging technology, which allows more natural 3D images and thus reduces eye strain of the viewers when viewing 3D images. Furthermore, the viewing angle is extended and 2D and 3D images can be selectively converted.

Also, since the viewing angle can be extended as the point light source array is separated from the mode converter, the point light source array can be installed either inside or outside of the mode converter. This enables easier manufacturing of a point light source array according to the kind of the point light source array.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image display comprising:
a display element modulating incident light from a point light source array to form an image; and
a mode converter placed between the point light source array and the display element and capable of being converted into a transparent medium and a scattering medium,
wherein the 3D image display device is in a 3D mode when the mode converter is a transparent medium and in a 2D mode when the mode converter is a scattering medium.

2. The image display device of claim 1, further comprising the point light source array, wherein the display element modulates the incident light pixel by pixel by electric control.

3. The image display device of claim 2, wherein the point light source array is disposed inside the mode converter.

4. The image display device of claim 1, wherein a refractive index of the mode converter is greater than 1.

5. The image display device of claim 2, further comprising a transparent medium having the same refractive index as the mode converter, wherein the point light source array is buried in the transparent medium.

6. The image display device of claim 1, wherein the mode converter comprises high polymer distributed liquid crystals.

7. The image display device of claim 2, wherein the point light source array is one of an arc lamp, a laser diode, and a light emitting diode arranged two dimensionally.

8. The image display device of claim 2, wherein optical fibers or a pin hole array is bonded between the point light source array and the mode converter.

9. An image display device comprising:
a correcting element correcting a divergence angle of light emitted from a point light source array;
a mode converter bonded with the correcting element and capable of being converted into a transparent medium and a scattering medium; and
a display element modulating incident light passing through the mode converter to form an image.

10. The image display device of claim 9, further comprising the point light source array, wherein the mode converter converts between the transparent medium and the scattering medium by electric control, and the display element modulates the incident light pixel by pixel by electric control.

11. The image display device of claim 10, wherein the point light source array comprises:
a light source;
a condensing lens focusing light emitted from the light source;
collimating lens collimating the light that passed through the condensing lens; and
a micro lens array having a plurality of unit micro lenses and focusing parallel light using the unit micro lenses to form a point light source array.

12. The image display device of claim 9, wherein the correcting element includes a lens array having a negative power.

13. The image display device of claim 11, wherein a refractive index of the mode converter is greater than 1.

14. The 3D image display device of claim 11, wherein the mode converter is formed of high polymer distributed liquid crystals.

15. The 3D image display device of claim 11, wherein the light source is one of an arc lamp, a laser diode, and a light emitting diode.

16. An image display device comprising:
a correcting element correcting a divergence angle of light emitted from a point light source array;
a transparent medium element bonded with the correcting element and having a refractive index greater than 1; and
a display element modulating incident light passing through the transparent medium element.

17. The image display device of claim 16, further comprising the point light source array, and wherein the display element modulates the incident light pixel by pixel by electric control.

18. The 3D image display device of claim 17, wherein the point light source array unit comprises:
a light source;
a condensing lens focusing light emitted from the light source;
a collimating lens collimating the light passing through the condensing lens; and
a micro lens array having a plurality of unit micro lenses and focusing parallel light using the unit micro lenses to form a point light source array.

19. The 3D image display device of claim 17, wherein the correcting element includes a lens array having a negative power.

20. The 3D image display device of claim 18, wherein the light source is one of an arc lamp, a laser diode, and a light emitting diode.
